(19) United States
(12) Patent Application Publication
(10) Pub. No.: US 2010/0016109 A1
(43) Pub. Date: Jan. 21, 2010

(54) SHEAVE METHOD AND SHEAVE SYSTEM

(76) Inventors: Stewart Walton, Mystic, CT (US); Richard Cazeault, Webster, MA (US)

Correspondence Address: LAW OFFICE OF MICHAEL A. BLAKE, LLC, 95 HIGH STREET, SUITE 5, MILFORD, CT, 06460, US

(21) Appl. No.: 12/567,331

(22) Filed: Sep. 25, 2009

Related U.S. Application Data
(63) Continuation-in-part of application No. 12/170,890, filed on Jul. 10, 2008, now Pat. No. 7,614,611.
Application No. 12/170,890 is a continuation-in-part of application No. 11/738,209, filed on Apr. 20, 2007.

(51) Int. Cl. F16H 55/36; B21K 1/42

(52) U.S. Cl. 474/199; 29/892.1

(57) ABSTRACT

A sheave system comprising: a sheave body, the sheave body comprising: a groove; a sheave body outer diameter; a sheave body inner diameter; one sheave sleeve selected from at least four sheave sleeves fixedly attachable to the sheave body inner diameter, each of the at least four of the sheave sleeves comprising: a sleeve bore; a sleeve outer diameter that is about the same as the sheave body inner diameter as to allow a fixed attachment between the sleeve and sheave body; a sleeve inner diameter; one bearing selected from at least four bearings fixedly attachable to the sleeve inner diameter, each of the bearings comprising: a bearing outer diameter that is about the same as the sheave body inner diameter as to allow a fixed attachment between the bearing and the sleeve, and a bearing inner diameter. A method of making a sheave system, the method comprising: determining an outer diameter of a sheave body; determining a rope size; selecting a sheave body; determining an outer diameter of a shaft; determining a bearing type; selecting a bearing; selecting a sheave sleeve; attaching the sheave sleeve to the sheave body; and attaching the bearing to the sheave sleeve.

### CROSS-REFERENCES

This application is a continuation-in-part application of U.S. Ser. No. 12/170,890 to Stewart Walton, Ser. No. 11/738,209, filed Jul. 10, 2008, to Stewart Walton, entitled “Sheave and Sheave System”, the contents of which are fully incorporated by reference herein.

### TECHNICAL FIELD

This invention relates generally to a sheave and a sheave system, and more particularly to a sheave and sheave system that can be easily adapted to various requirements of users.

### BACKGROUND

Sheaves are grooved wheels or pulleys used with rope, cable, line, wire or chain. Sheaves are often used to change the direction and point of application of pulling force. Selecting sheaves requires an analysis of product specifications, including but not limited to: cable size, outer diameter (OD) of the sheave, the material the sheave is to be made out of, the bore size, the sheave body width, the type of groove, the type and size and bearing that fits in the bore. Manufacturing and supplying the properly specified sheaves to a customer may take anywhere from 4 to 26 weeks.

Accordingly, there is a need for a sheave that can be provided to customer with shorter lead times and or lower inventory costs.

### SUMMARY

The disclosed invention relates to a sheave system comprising: a sheave body, the sheave body comprising: a groove; a sheave body outer diameter; a sheave body inner diameter; one sheave sleeve selected from at least four sheave sleeves fixedly attachable to the sheave body inner diameter, each of the at least four of the sheave sleeves comprising: a sleeve bore; a sleeve outer diameter that is about the same as the sheave body inner diameter as to allow a fixed attachment between the sleeve and sheave body; a sleeve inner diameter; one bearing selected from at least four bearings fixedly attachable to the sleeve inner diameter, each of the bearings comprising: a bearing outer diameter that is about the same as the sheave body inner diameter as to allow a fixed attachment between the bearing and the sleeve, and a bearing inner diameter.

The disclosed invention also relates to a sheave system comprising: a sheave body, the sheave body comprising: a groove; a sheave body outer diameter; a sheave body inner diameter; one sheave sleeve selected from at least four sheave sleeves fixedly attachable to the sheave body inner diameter, each of the at least four of the sheave sleeves comprising: a sleeve bore; a sleeve outer diameter that is about the same as the sheave body inner diameter as to allow a fixed attachment between the sleeve and sheave body; a sleeve inner diameter; one bearing selected from at least four bearings fixedly attachable to the sleeve inner diameter, each of the bearings comprising: a bearing outer diameter that is about the same as the sheave body inner diameter as to allow a fixed attachment between the bearing and the sleeve, and a bearing inner diameter; one bearing insert selected from at least four bearing inserts rotatedly attachable to a bearing inner diameter, each of the at least four bearing inserts comprising: a bearing insert outer diameter that is about the same as a bearing inner diameter as to allow a rotatable attachment between the bearing insert and the bearing; and a bearing insert inner diameter, the inner diameter configured to fixedly attach to a shaft.

The disclosed invention, in addition, relates to a method of making a sheave system, the method comprising: determining an outer diameter of a sheave body; determining a rope size; selecting a sheave body; determining an outer diameter of a shaft; determining a bearing type; selecting a bearing; selecting a sheave sleeve; attaching the sheave sleeve to the sheave body; and attaching the bearing to the sheave sleeve.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a perspective exploded view of one embodiment of the disclosed sheave;

FIG. 2 is a cross-sectional view of the sheave from FIG. 1;

FIG. 3 is a perspective exploded view of another embodiment of the disclosed sheave;

FIG. 4 is a cross-sectional view of the sheave from FIG. 3; and

FIG. 5 is a flowchart illustrating a method of the invention.

### DETAILED DESCRIPTION

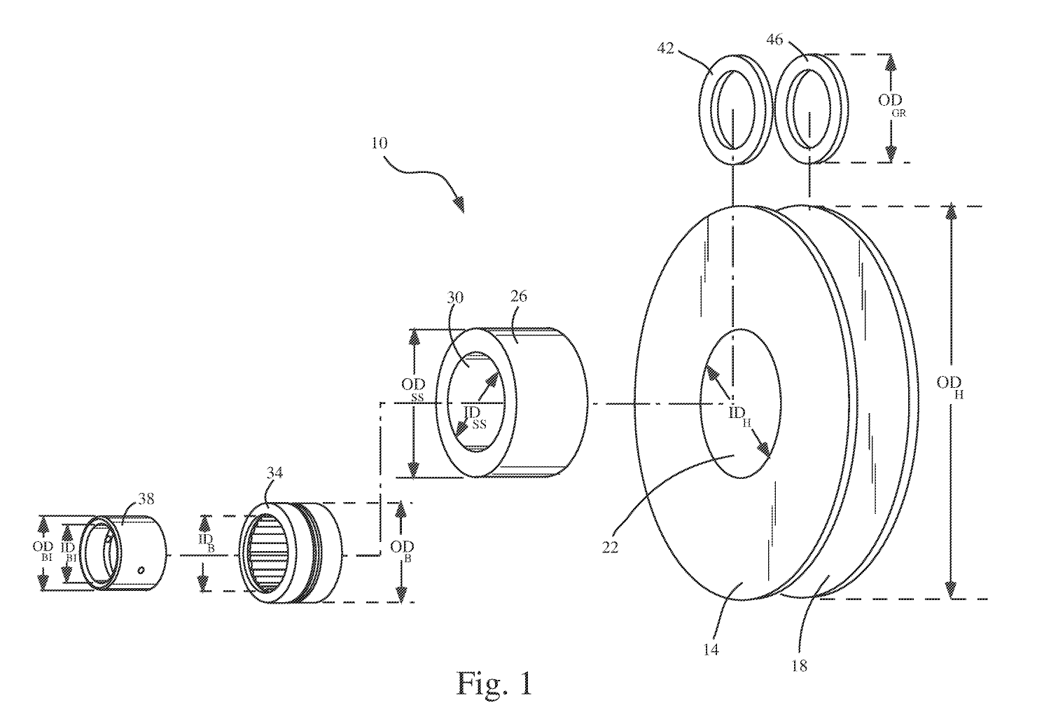

FIG. 1 is an exploded perspective view of one embodiment of the disclosed sheave 10. The sheave comprises a grooved sheave body 14. The sheave body 14 comprises a groove 18, and a sheave bore 22 with an inner diameter ID_{H}. The sheave body has an outer diameter OD_{H}. A sheave sleeve 26 has an outer diameter OD_{SS} and a sleeve bore 30 with an inner diameter ID_{SS}. The sheave sleeve 26 is configured to fit in the sheave body bore 22. OD_{SS} may be sized with the respect to the ID_{H} such that the sheave sleeve 26 may be press fit into the sheave body 14. In other embodiments, the sheave sleeve 26 may have an interference fit with the sheave bore 22, or the sheave sleeve 26 may be otherwise attached to the sheave bore 22, such as but not limited to a tack weld. In this embodiment of the disclosed sheave 10, the sheave sleeve 26 is configured to allow a bearing 34, such as but not limited to a roller bearing, to be press fit into the sleeve bore 30. The bearing has an outer diameter OD_{B}. In one embodiment the bearing 34 may be fitted directly onto a shaft. The bearing has an inner diameter ID_{B}. In other embodiment, a bearing insert 38 may be rotatedly attached to the bearing's ID_{B}, and be non-rotatably attached to a shaft via the bearing insert's inner diameter ID_{BI}. The bearing insert 38 will also have an outer diameter OD_{BI}. The bearing insert 38 may also be known as a bearing race. In other embodiments, optional grease retainers 42, 46, each with an outer diameter of OD_{GR} will fit within the sheave sleeve bore 30, and are configured to retain lubricant within the sleeve bore 30, thus providing for lubrication to the bearing 34.

In this disclosure a bearing shall be defined to be a device that allows constrained relative motion between two or more parts, typically rotation or linear movement, and shall include, but is not limited to: cylindrical roller bearings with and without inner races; sleeve bearings of all materials (also including bushings), metallic and non-metallic; ball bearings; and tapered rollers bearings.

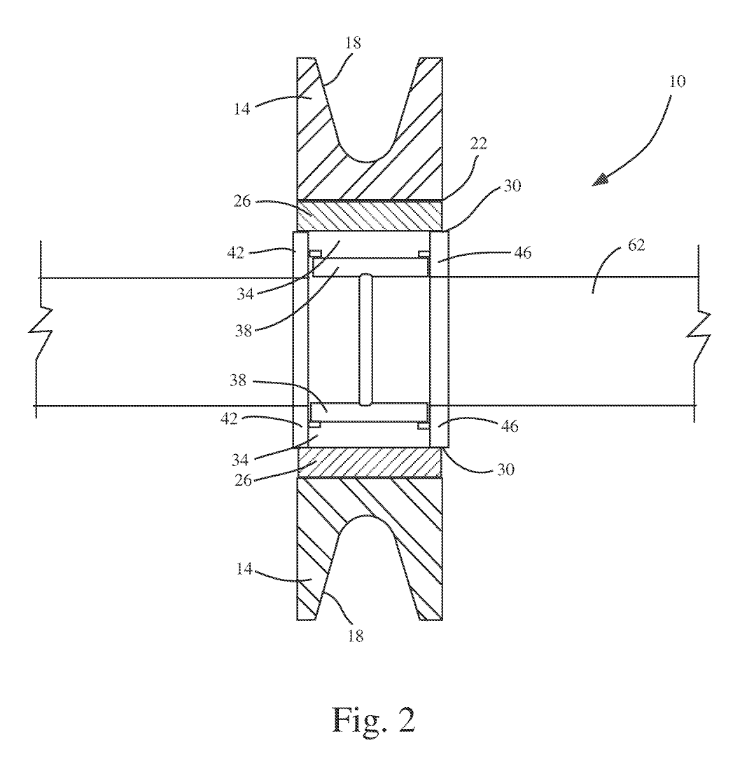

FIG. 2 shows a cross-sectional view of the sheave 10 above, assembled and with the sheave in rotatable communication with a shaft 62.

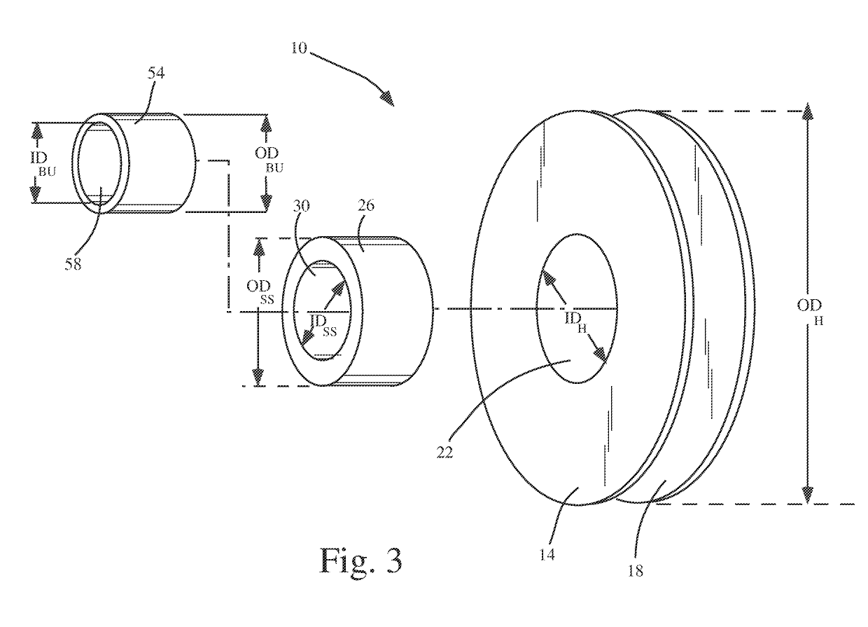

FIG. 3 shows an exploded perspective view of another embodiment of the disclosed sheave 50. The sheave 50 comprises a grooved sheave body 14. The sheave body 14 comprises a groove 18, and a sheave bore 22 with an inner diameter ID_{H}, the sheave body has an outer diameter OD_{H}. A sheave sleeve 26 has an outer diameter OD_{SS} and a sleeve bore 30 with an inner diameter ID_{SS}. The sheave sleeve 26 is configured to fit in the sheave bore 22. OD_{SS} may be sized with the respect to the ID_{H} such that the sheave sleeve 26 may be press fit into the sheave body 14. In other embodiments, the sheave sleeve 26 may have an interference fit with the sheave bore 22, or the sheave sleeve 26 may be otherwise attached to the sheave bore 22, such as but not limited to a tack weld. In this embodiment of the disclosed sheave 10, the sheave sleeve 26 is configured to allow a sleeve bearing 54, such as but not limited to a bronze sleeve bearing, to be press fit into the sleeve bore 30. The sleeve bearing 54 has an outer diameter OD_{BU} and an inner diameter ID_{BU}. The sleeve bearing 54 has a bore 58 configured to allow a shaft to be in rotatable communication with the sleeve bearing 54, and located within the sleeve bearing 54. In one embodiment the sleeve bearing 54 may be fitted directly onto a shaft, via the ID_{BU}.

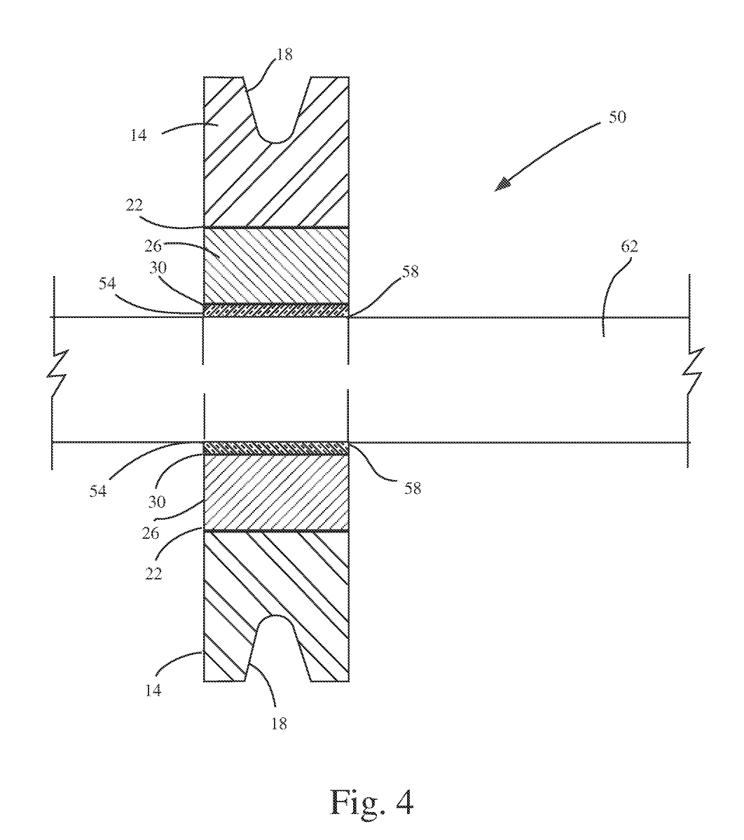

FIG. 4 shows a cross-sectional view of the sheave 50 above, assembled and with the sheave 50 in rotatable communication with a shaft 62.

TABLE 1

| | | Bronze Sleeve Bearing | | | | Roller Bearing | | | |
|---|---|---|---|---|---|---|---|---|---|
| Rope | Shaft | 6″ | 8″ | 10″ | 12″ | 6″ | 8″ | 10″ | 12″ |
| Size | Size | OD | OD | OD | OD | OD | OD | OD | OD |
| ⅜ | 1.000 | X | X | X | X | | | | |
| | 1.250 | X | X | X | X | | | | |
| | 1.500 | X | X | X | X | X | X | X | X |
| | 1.625 | X | X | X | X | X | X | X | X |
| | 1.750 | X | X | X | X | X | X | X | X |
| | 2.000 | X | X | X | X | X | X | X | X |
| | 2.250 | X | X | X | X | | | | |
| 7/16 | 1.000 | X | X | X | X | | | | |
| | 1.250 | X | X | X | X | | | | |
| | 1.500 | X | X | X | X | X | X | X | X |
| | 1.625 | X | X | X | X | X | X | X | X |
| | 1.750 | X | X | X | X | X | X | X | X |
| | 2.000 | X | X | X | X | X | X | X | X |
| | 2.250 | X | X | X | X | | | | |
| ½ | 1.000 | X | X | X | X | | | | |
| | 1.250 | X | X | X | X | | | | |
| | 1.500 | X | X | X | X | X | X | X | X |
| | 1.625 | X | X | X | X | X | X | X | X |
| | 1.750 | X | X | X | X | X | X | X | X |
| | 2.000 | X | X | X | X | X | X | X | X |
| | 2.250 | X | X | X | X | | | | |
| 9/16 | 1.000 | X | X | X | X | | | | |
| | 1.250 | X | X | X | X | | | | |
| | 1.500 | X | X | X | X | X | X | X | X |
| | 1.625 | X | X | X | X | X | X | X | X |
| | 1.750 | X | X | X | X | X | X | X | X |
| | 2.000 | X | X | X | X | X | X | X | X |
| | 2.250 | X | X | X | X | | | | |
| ⅝ | 1.000 | X | X | X | X | | | | |
| | 1.250 | X | X | X | X | | | | |
| | 1.500 | X | X | X | X | X | X | X | X |
| | 1.625 | X | X | X | X | X | X | X | X |
| | 1.750 | X | X | X | X | X | X | X | X |
| | 2.000 | X | X | X | X | X | X | X | X |
| | 2.250 | X | X | X | X | | | | |

In one example of use of the disclosed invention, various sized grooved sheave bodies will be available (the various sized grooved sheave bodies may have different outer diameters, and groove sizes, as well as other differing specifications), however, each of the different sized grooved sheave bodies will have the same ID_{H}. Thus, one may have a plurality of 12 inch sheaves (12 inch OD_{H}), and a plurality of 6 inch sheaves (6 inch OD_{H}). However, both the 12 inch sheaves and the 6 inch sheaves will have the same ID_{H}. Thus, in order to fit the sheaves onto different sized shafts, one simply uses a sheave sleeve with an OD_{SS} that is configured to fit in the ID_{H} of either the 12 inch sheave or the 6 inch sheave, with the sheave sleeve being sized to have an ID_{SS} to accommodate the bearing, or sleeve bearing that will fit over the shaft. Table 1, above, shows the variety of sheaves that a sheave manufacture may be required to produce for a customer. The first column is the diameter of various rope sizes that may be required to fit in the groove of the sheave. In this document, the word rope shall be broadly defined to mean a long slender flexible length of material that can be used for pulling, but is not normally useful for pulling, and shall include, but is not limited to rope, cable, line, wire and chain The second column is the outer diameter of the shaft that may attached to a sleeve bearing, such as but not limited to a bronze sleeve bearing, or to a bearing, such as but not limited to a roller bearing. Thus, for a ⅜ inch rope, the shaft sizes that should be available to a customer range from about 1.000 inch to about 2.250 inches. The third through sixth columns indicate that sheaves with ODs ranging from 6″ to 12″ are available with bronze sleeve bearings to accept all indicated shaft sizes (1.000 to 2.250) for a rope size of ⅜ inch. The seventh through tenth columns indicate that sheaves with ODs ranging from 6″ to 12″ are available to fit roller bearings that can accept shaft sizes of 1.5 to 2 inches (as shown by the Xs). The table shows four sheave sizes (6″ OD, 8″ OD, 10″ OD, and 12″ OD), five common rope sizes; seven popular shaft sizes with bronze sleeve bearings; and four popular shaft sizes with roller bearings. These sizes lead to 220 configurations of sheaves that may be specified by a customer. Thus, without the invention full stocking for quick delivery requires a supply of 220 sheave configurations. However, with the invention, full stocking for quick delivery requires: 20 common bore sheaves (5 rope sizes×4 sheave ODs); 5 sleeves; 7 bronze sleeve bearings; 4 roller bearings, a total of 36 components to be able to make any of the 220 sheave configurations. If a prudent sheave manufacture wants to be able to immediately ship out 10 of any type of sheave, then without the invention, the manufacturer would have to carry 2,220 sheaves, as opposed to only 360 components (with the invention). It can be seen from Table 1, that there is a ratio of sheave outer diameters to sleeve bearing inner diameters that range from about 6 to about 2.67 for column 3, from about 8 to about 3.56 for column 4, from about 10 to about 4.44 for column 5, and from about 12 to about 5.33 for column 6. Additionally, it can be seen from Table 1, that there is a ratio of sheave outer diameters to bearing inner diameters that range from about 4 to about 3 for column 7, from about 5.33 to about 4 for column 8, from about 6.67 to about 5 for column 9, and from about 8 to about 6 for column 10.

Thus, the inventory cost for using the disclosed invention is much lower than if one had to assemble sheaves according to customer specification without the disclosed invention. For example, if a manufacturer were to provide for sheave sizes of 6, 8, 10 and 12 inches (OD_{H}), and the capacity to handle rope sizes of ½, 9/16, ⅝, ¾ and 1 inch (the rope will communicate with the sheave via the groove 18), and 7 different bore sizes (the bore sizes corresponding to the size of the bore required to accept the shaft, in one example this would be the inner diameter of the sleeve bearing 54, or in another example, this would be the inner diameter of the roller bearing insert 38, this would lead to 390 combinations of unique sheaves. In order to make 10 units of any particular sized sheave, using the disclosed invention, the inventory costs to stock the sheaves, sleeves, and bearings would be less than $10,000. However, without the invention, the inventory costs to be able to make 10 units of any particular sized sheaves out of the 390 different possible combinations would be over $750,000, due to the number of parts required to have on hand to be able to produce the variety sheaves that may be required by users. Without using the disclosed invention, one must have in stock a different sized sheave, each sheave having a specific groove size, specific outer diameter, and a specific inner diameter to fit a specific bearing size and/or sleeve bearing size.

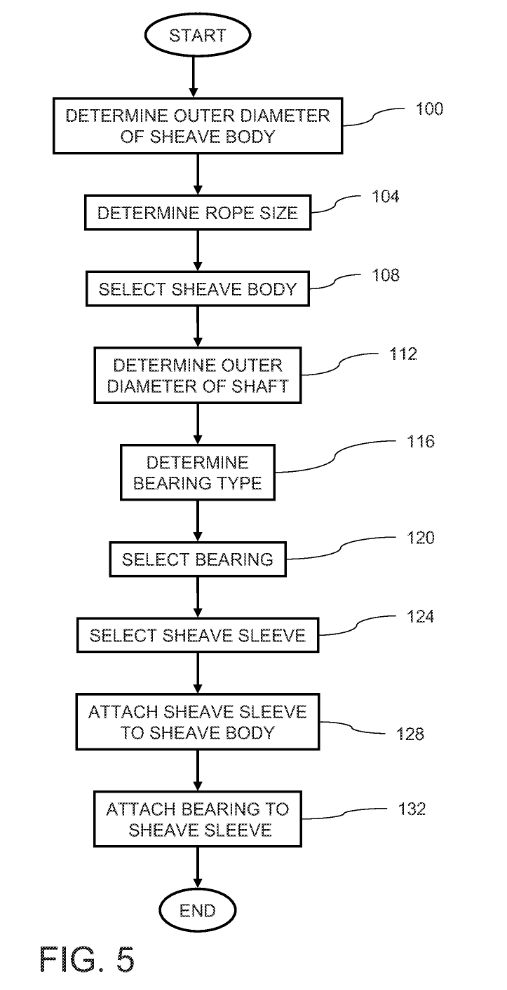

Referring now to FIG. 5, a method of the invention is disclosed. At act 100 a user determines the outer diameter of the sheave body. At act 104, the user determines the rope size. The user may include the end user of the sheave system, or a salesman filling an order for a customer, or a technician building the sheave system, or a combination of the previously listed or other users. At act 108, the user selects the sheave body. The sheave body to be selected may be based on the information obtained at acts 100 and 104, and thus selects the proper sized sheave body. At act 112 the user determines the outer diameter of the shaft. At act 116 the user determines the bearing type to be used in the sheave system. At act 120, a bearing is selected. The bearing may be selected based on the information obtained at act 112. At act 124, the user selects the sheave sleeve. The sheave sleeve may be selected based on the information obtained at act 120, and thus selects the properly sized sheave sleeve. At act 128, the sheave sleeve is attached to the sheave body. The sheave sleeve may be generally permanently attached to the sheave body. In one method, the sheave sleeve may be pressed fit into the sheave body. In other embodiments, the sheave sleeve may be pressed fit into the sheave body and also using an adhesive to attach the sheave sleeve inside the sheave body, such an adhesive may include Loctite®. At act 132 the bearing may be attached to the sheave sleeve. The bearing may be removably attached to the sheave sleeve, in order to replace the bearing if and when the bearing wears out or fails.

The disclosed sheave and sheave system has many advantages. It allows one to produce sheaves according to a variety of specifications, at a much lower inventory cost. Using the disclosed invention, one need not stock sheaves with many different sizes of inner diameters, but rather just one or a few inner diameters would be necessary, because one would vary the size of bearing or sleeve bearing that the sheave could hold by using different sized sheave sleeves. The invention shortens the lead time to manufacture a sheave to about 72 hours or less. With the invention, sheave manufacturer can have a variety of sheaves stocked in his inventory, i.e. sheaves with different OD's, sheave body widths, and groove types, but each of the variety of sheaves will have the same inner diameter to fit a sheave sleeve. Additionally, the sheave manufacturer can have a variety of sheave sleeves with different sized bores (the inner bore size of the sleeve that the customer specified) in his inventory. Using this system of sheaves and sheave sleeves, will allow the manufacturer to maintain a manageable inventory of sheave sizes, sheave sleeve sizes, and bearings. Thus, by simply combining the proper sheave with the proper sheave sleeve and the proper bearing, a manufacturer can produce the specified sheaves for a client much quicker with inventory on hand, as opposed to having to custom manufacture each sheave order, which can take up to 4 to 26 weeks. In the example discussed above, the invention reduces the number of sheaves from 220 to 20. The invention increases manufacturing efficiencies because 20 different sheaves (for example) have fewer set-ups and longer runs than 220 different sheaves (for example). The invention facilitates customization for special requirements. Special sleeves can be made on a custom basis to provide for a wider bearing, ball bearings, and special sleeve bearings. The cost and lead-time savings over a 100% custom sheave are large. Another advantage of the disclosed system is that two parameters—sheave body outer diameter and rope size—may be isolated from two other parameters—shaft size and bearing type. A new element, the sheave sleeve, is available to marry these two sets of parameters. The sheave body inner diameter and the sheave sleeve outer diameter may have a common nominal dimension throughout a family of sheaves. Thus, for example, for a 6″ through 12″ family this nominal diameter may be about 2 and 9/16 inches. For a 12″ through 16″ family of sheaves, the nominal diameter may be about 5 and ¼ inches.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A sheave system comprising:
a sheave body, the sheave body comprising:
a groove;
a sheave body outer diameter;
a sheave body inner diameter;
one sheave sleeve selected from at least four sheave sleeves fixedly attachable to the sheave body inner diameter, each of the at least four of the sheave sleeves comprising:
a sleeve bore;
a sleeve outer diameter that is about the same as the sheave body inner diameter as to allow a fixed attachment between the sleeve and sheave body;
a sleeve inner diameter;
one bearing selected from at least four bearings fixedly attachable to the sleeve inner diameter, each of the bearings comprising:
a bearing outer diameter that is about the same as the sheave body inner diameter as to allow a fixed attachment between the bearing and the sleeve, and
a bearing inner diameter.

2. The sheave system of claim 1, where the bearing is selected from the group consisting of cylindrical roller bearings without inner races; metallic sleeve bearings, non-metallic sleeve bearings; bronze sleeve bearings; ball bearings; and tapered rollers bearings.

3. A sheave system comprising:
a sheave body, the sheave body comprising:
a groove;
a sheave body outer diameter;
a sheave body inner diameter;
one sheave sleeve selected from at least four sheave sleeves fixedly attachable to the sheave body inner diameter, each of the at least four of the sheave sleeves comprising:
a sleeve bore;
a sleeve outer diameter that is about the same as the sheave body inner diameter as to allow a fixed attachment between the sleeve and sheave body;
a sleeve inner diameter;
one bearing selected from at least four bearings fixedly attachable to the sleeve inner diameter, each of the bearings comprising:
a bearing outer diameter that is about the same as the sheave body inner diameter as to allow a fixed attachment between the bearing and the sleeve, and
a bearing inner diameter;
one bearing insert selected from at least four bearing inserts rotatedly attachable to a bearing inner diameter, each of the at least four bearing inserts comprising:
a bearing insert outer diameter that is about the same as a bearing inner diameter as to allow a rotatable attachment between the bearing insert and the bearing; and
a bearing insert inner diameter, the inner diameter configured to fixedly attach to a shaft.

4. The sheave system of claim 3, where the bearing is selected from the group consisting of cylindrical roller bearings; ball bearings; and tapered rollers bearings.

5. A method of making a sheave system, the method comprising:
determining an outer diameter of a sheave body;
determining a rope size;
selecting a sheave body;
determining an outer diameter of a shaft;
determining a bearing type;
selecting a bearing;
selecting a sheave sleeve;
attaching the sheave sleeve to the sheave body; and
attaching the bearing to the sheave sleeve.

6. The method of claim 5, wherein the attaching the sheave sleeve to the sheave body act is done via a press fit.

7. The method of claim 5, wherein the attaching the sheave sleeve to the sheave body act is done via a press fit and an adhesive.
